(19) United States
(12) Patent Application Publication
(10) Pub. No.: US 2008/0016127 A1
(43) Pub. Date: Jan. 17, 2008

(54) Utilizing software for backing up and recovering data

(75) Inventor: Scott A. Field, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/479,261

(22) Filed: Jun. 30, 2006

(51) Int. Cl. G06F 17/30

(52) U.S. Cl. 707/202; 707/4

(57) ABSTRACT

A method of utilizing software for backing up and recovering data is disclosed. The method separates the backup functionality and the restore functionality of the software into at least two independent operations. The backup functionality is isolated from the restore functionality. The backup functionality comprises encrypting the data and the restore functionality comprises decrypting the data.

### BACKGROUND

Over time in a typical computer environment large amounts of data are typically written to and retrieved from storage devices connected to the computer. As more data are exchanged with the storage devices, it becomes increasingly difficult to reproduce these data if the storage devices fail. In an increasingly technologically complex world, the maintenance and storage of data is also increasingly important. In order to mitigate the risk of losing data, one common way of protecting data is by backing up the data to a storage location. Such a backup operation is typically performed manually or automatically at preset intervals using backup software.

Traditionally, backup software allows for both the ability to backup and to subsequently restore data. Thus, most backup software has the ability to both read and write to any file on a system. However, from a security perspective, the ability to read and write to any file on a system using a traditional backup software may render the system vulnerable to several data security problems.

For example, in an non-compartmentalized backup software, where the backup functionality of the software is connected to the restore functionality of the software, if the restore functionality of the software is compromised by a virus, the backup functionality may easily also be compromised by the virus, which may result in tampering with existing backup data or other files on the system

Another example of vulnerability posed by the traditional backup software may deal with access issues. For example, in a traditional backup software separate sets of people may access the same set of data. In an enterprise context, this means employees in charge of backing up data may access and/or tamper with data that has already been backed up, while employees working with backed up data may tamper with data to be backed up, or vice versa. An additional access security risk may also include privacy issues associated with allowing the backup software and/or the backup software user, to read in cleartext, data to be backed up onto a storage media.

In addition, because highly sensitive information, such as financial records, personnel records, personal data, and proprietary information, may be of substantial economic value to hackers/attackers, these types of data are frequently the target of unauthorized access, or malicious coding by hackers/attackers. In one scenario, an attacker may access and corrupt backed up data of a system by accessing the traditional backup software of the system which allows the hacker to not only read backup data, but also write malicious code and/or corrupted data into backup and/or even the original data files.

### SUMMARY

Technology for utilizing software for backing up and recovering data is disclosed. The technology separates the backup functionality and the restore functionality of the software into at least two independent operations. Isolating the backup functionality from the restore functionality provides one level of protection. Furthermore, the backup functionality includes encrypting the original data with a key and storing the key in a safe place that is not accessible by the backup software. The restore functionality decrypts the encrypted data by using the key. Thereby, even if the backup or restore software is hacked, the data is secured because of the encryption.

### BRIEF DESCRIPTION OF THE DRAWINGS

The accompanying drawings, which are incorporated in and form a part of this specification, illustrate embodiments of the present claimed subject matter and, together with the description, serve to explain the principles of the claimed subject matter:

FIG. 1A is a flowchart illustrating an exemplary method of archiving data, in accordance with an embodiment of the present claimed subject matter.

FIG. 1B is a flowchart illustrating an exemplary method of encrypting backup data, in accordance with an embodiment of the present claimed subject matter.

FIG. 1C is a flowchart illustrating an exemplary method of encrypting backup data, in accordance with an embodiment of the present claimed subject matter.

FIG. 2 is a block diagram illustrating an exemplary system for backing up and restoring file data, in accordance with an embodiment of the present claimed subject matter.

FIG. 3A is a diagram illustrating an exemplary software for backing up and recovering data, in accordance with an embodiment of the present claimed subject matter.

FIG. 3B is a flowchart illustrating an exemplary encrypting process, in accordance with an embodiment of the present claimed subject matter.

FIG. 3C is a flowchart illustrating an exemplary decrypting process, in accordance with an embodiment of the present claimed subject matter.

FIG. 4 illustrates an exemplary environment for implementing the claimed subject matter, in accordance with an embodiment of the present claimed subject matter.

FIG. 5 is a block diagram of an exemplary backup scenario based on virtual machine isolation, in accordance with an embodiment of the present claimed subject matter.

FIG. 6 is a block diagram of an exemplary backup scenario based on account/process isolation and kernel isolation, in accordance with an embodiment of the present claimed subject matter.

FIG. 7 is a block diagram of an exemplary restore scenario based on account/process isolation, in accordance with an embodiment of the present claimed subject matter.

### DETAILED DESCRIPTION

Reference will now be made in detail to the preferred embodiments of the present claimed subject matter, examples of which are illustrated in the accompanying drawings. While the claimed subject matter will be described in conjunction with the preferred embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present claimed subject matter, numerous specific details are set forth in order to provide a thorough understanding of the present claimed subject matter. However, it will be obvious to one of ordinary skill in the art that the present claimed subject matter may be practiced without these specific details. In other instances, well known methods, procedures, components, and circuits have not been described in detail as not to unnecessarily obscure aspects of the present claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

In overview, embodiments of the present claimed subject matter provide methods and systems of utilizing software for backing up and recovering data (also referred to herein as archiving data) through the encryption and/or the decryption of data (also referred to as encrypting and decrypting, respectively). In addition, embodiments of the present claimed subject matter may also include separating the backup process (also referred to as the backup functionality) and the restoring process (also referred to as the restore functionality) into at least two distinct operations, which are performed by separate code modules. In such embodiments, such role separation also helps to limit security risks to a system in several ways. For example, in the context of corrupted files and malicious code, separating the backup functionality from the restore functionality translates to enhanced containment of the corrupted files and the malicious code and therefore decreased security vulnerabilities.

In some instances, embodiments of the present claimed subject matter also provide access control of the backup and recovery process. For example, as used herein, the term encrypting refers to the process of backing up data in which the data to be backed up is encoded with a key, while the term decrypting refers to the process of restoring backed up data in which the data to be restored is decoded with a key. To illustrate what is meant by access control, in one embodiment, in order for a user to access a file for backup, the access controlled backing up process would verify the user's privilege and encode the data for backup using a key. Furthermore, because the key is a key that is not accessible to the access controlled backing up process (also referred to as the encryption process) and because the access controlled restoring process (as referred to as the decryption process) also requires a privilege check to obtain the same key, security vulnerabilities in the backup/restore software and/or the system are reduced. Thus, more specifically, certain embodiments of the present claimed subject matter allow for increased security benefits while backing up or restoring data through the use of access controls, such as cryptographic encryption, integrity and privilege checks, during the backing up and/or the restoring process.

Furthermore, embodiments of the present claimed subject matter may be implemented in various ways. For example, in some instances, embodiments of the present claimed subject matter also include the use of virtual machine technologies. In other instances, embodiments of the present claimed subject matter further include the use of Hypervisor partitions, or user account based isolation.

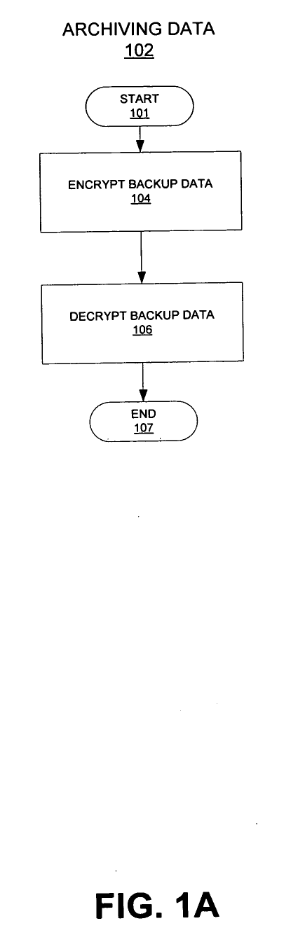

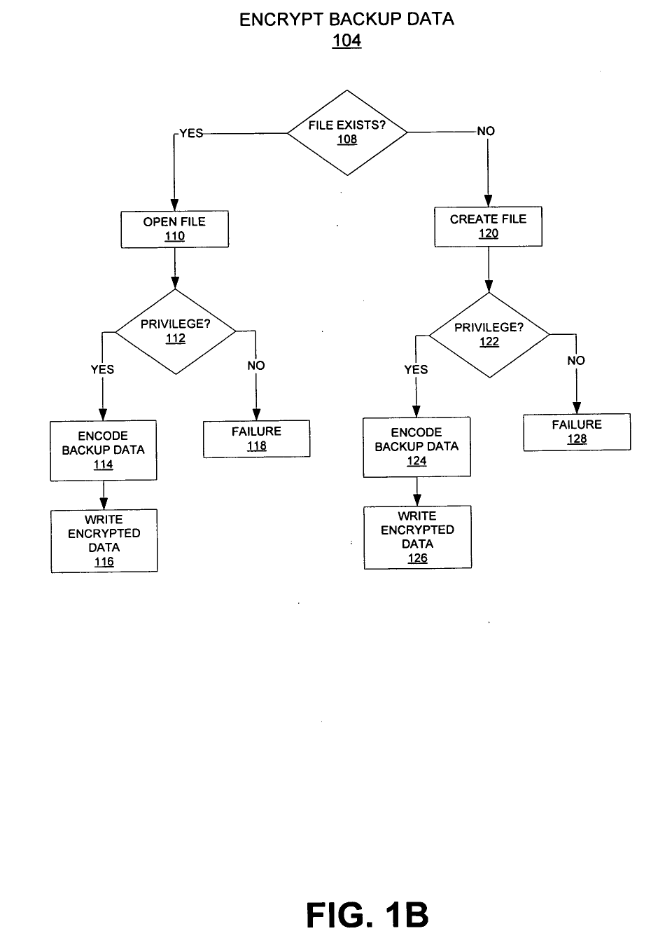

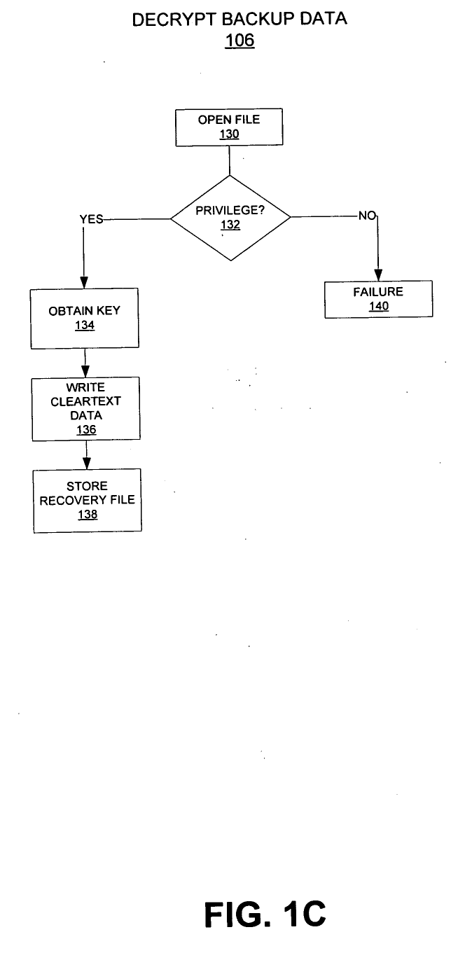

FIG. 1A is a flowchart illustrating an exemplary method 102 of archiving data, in accordance with an embodiment of the present claimed subject matter. Exemplary method 102 may be implemented in various ways. For example, in one embodiment, method 102 is implemented on a single computing device, while in another embodiment; method 102 is implemented on a network. In yet another embodiment, method 102 is implemented through the use of virtual machine technologies. Also, although specific steps are disclosed in flowchart 102, such steps are exemplary. That is, various embodiments are well suited to performing a variety of other additional steps or variations of the steps recited in flowchart 102. The steps in flowchart 102 may also be performed in an order different than presented. As depicted in FIG. 1A, in block 101, the process starts.

At block 104, in one embodiment, backup data is encrypted (see FIG. 1B for a breakdown of an exemplary encrypting process). Backup data refers to desired data to be backed up. Backup data may include a variety of data, such as, but not limited to file data. At block 106, in one embodiment, backup data is decrypted (see FIG. 1C for a breakdown of an exemplary decrypting process). The encrypting process and the decrypting process may be processes that are isolated and separated from one another. In one embodiment, the encrypting process and the decrypting process may be separate operations that resulted from the refactoring of backup software. In such embodiments, the encrypting process and the decrypting process may operate independently of each other. For example, in one embodiment, the method 102 of archiving data does not include the decrypting process 106. Referring back now to FIG. 1A, at block 107, the process ends.

Referring now to FIG. 1B, a flowchart detailing an exemplary method of encrypting backup data as depicted in block 104 of FIG. 1A is illustrated. At block 108, in one embodiment, a determination of whether a file associated with the data to be backed up exists is made. In one embodiment, if the file does exist, the process continues from block 108 to block 116, where encrypted data is written to a storage location. In another embodiment, if the file does not exist, the process continues from block 108 to block 126, where encrypted data is also written to a storage location. However, in yet other embodiments, if a privilege is not held by a user, a failure is returned at either block 118 or block 128 of FIG. 1B. The user referred to herein may be, but is not limited to, an end user, an individual user device, or an application program. There may also be more than one user. Also, although specific steps are disclosed in flowchart 104, such steps are exemplary. That is, various embodiments are well suited to performing a variety of other additional steps or variations of the steps recited in flowchart 104. The steps in flowchart 104 may also be performed in an order different than presented.

Still referring to FIG. 1B, in a more detailed context of an embodiment in which the file does exist, at block 110, the file is opened using backup software. At block 112, in one embodiment, verification of whether a privilege associated with the file is held occurs. At block 114, in one embodiment, if the privilege is held, the backup data is encoded with a key that is not accessible to the backup software (also referred to as the backup functionality). A key may be, but is not limited to, a domain public key, a smartcard, a Trusted Platform Module (TPM) based key, a hardware based token, or a key provided by the user of the system. In addition, a key may be accessible by the restore functionality of software and access to the key may be based on input from a user. In one embodiment, the encoding transforms the backup data into encrypted data. At block 116, in one embodiment, the encrypted data is written to a storage location. A storage location may include, but is not limited to, a local media, a remote media, and/or a service provider such as an internet web service. In an embodiment where the privilege is not held, at block 118, a failure is returned. In one embodiment, when a failure is returned, backup data is not encoded into encrypted data and data is not stored. In another embodiment, when a failure is returned, access to a backup file is denied.

Referring now to a detailed embodiment in which the file referred to in block 108 does not exist, in block 120, a new file is created. In one embodiment, the process from block 120 on to block 126 and/or block 128 is similar to the process from block 110 to block 116 and/or block 118. In one embodiment, in block 122, verification of whether a privilege associated with the new file is held occurs. In one embodiment, if the privilege is held, in block 124, backup data is encoded with a key that is not accessible to the backup software, transforming the backup data into encrypted data. In one embodiment, in block 126, the encrypted data is further written to a storage location such as, but not limited to, a local media, a remote media, and a service provider. In an embodiment where the privilege referred to in block 122 is not held, a failure is returned.

In reference now to FIG. 1C, a flowchart of an exemplary method of decrypting backup data 106 as depicted in block 106 of FIG. 1A is illustrated, in accordance with an embodiment of the present claimed subject matter. The exemplary method of decrypting backup data 106, as depicted in FIG. 1C, may occur independently of and isolated from the method of encrypting backup data (e.g., method 104 of FIGS. 1A and 1B), or it may occur as a separate event in time. In one embodiment, in block 130, a file associated with encrypted data is opened by a restore program. In block 132, in one embodiment, a new privilege check is conducted, resulting in either the process continuing from block 132 to block 138, where a recovery file is stored, or the process from block 132 to block 140 directly, where a failure is returned. Although specific steps are disclosed in flowchart 106, such steps are exemplary. That is, various embodiments are well suited to performing a variety of other additional steps or variations of the steps recited in flowchart 106. The steps in flowchart 106 may also be performed in an order different than presented.

Still in reference to FIG. 1C, in one embodiment, if a privilege is confirmed to be held, at block 134, a key associated with the encrypted data that is not accessible to the backup software obtained. The key obtained may be used to decode the encrypted data and/or to transform the encrypted data to cleartext data. In one embodiment, at block 136, cleartext data associated with the encrypted data is written to a recovery file. In one embodiment, the process continues to block 138 where the recovery file is stored in a storage location such as, but not limited to, in a local media, in a remote media, and a in service provider location. In another embodiment, the process ends at block 136 and does not continue to block 138. In yet another embodiment, in the context of an embodiment in which the privilege referred to in block 132 is not held, a failure is returned.

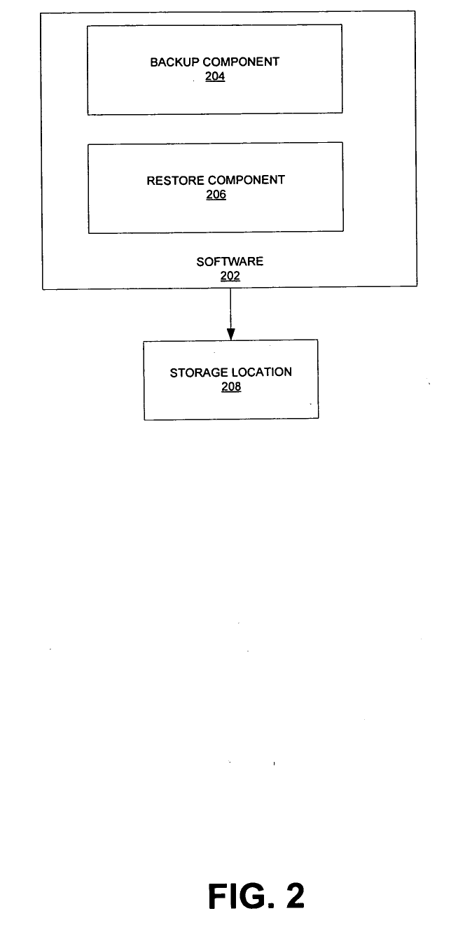

Referring now to FIG. 2, a block diagram of an exemplary system for backing up and restoring file data is depicted, in accordance with an embodiment of the present claimed subject matter. The system for backing up and restoring file data as depicted in FIG. 2 includes a storage location 208 coupled with a software 202, which further includes a backup component 204 and a restore component 206. Although the system of FIG. 2 is shown and described as having certain numbers and types of elements, the present embodiment is not so limited; that is, system of FIG. 2 may include elements other than the ones shown, and may also include more than one of the elements that are shown.

In reference to FIG. 2, the system is described in the context of an example in which the backup component 204 and the restore component 206 are independent components in the form of separate code modules operating independently of one another within software 202. Furthermore, in the context described, because the backup component 204 and the restore component 206 are isolated operations security vulnerabilities within and through the system may be limited.

Referring back now to FIG. 2, the storage location 208 is a location in which files (e.g., recovery files), data (e.g., encrypted data, encoded data, backup data) may be stored. The storage location 208 may include locations such as, but not limited to local media locations, remote media locations, and service provider locations. In one embodiment, the backup component 204 conducts the encrypting process (e.g., encrypting process 104 of FIGS. 1A and 1B), while the restore component conducts the decrypting process (e.g., decrypting process 106 of FIGS. 1A and 1C). In another embodiment, data may be transformed into encrypted data through the use of a crypto handler.

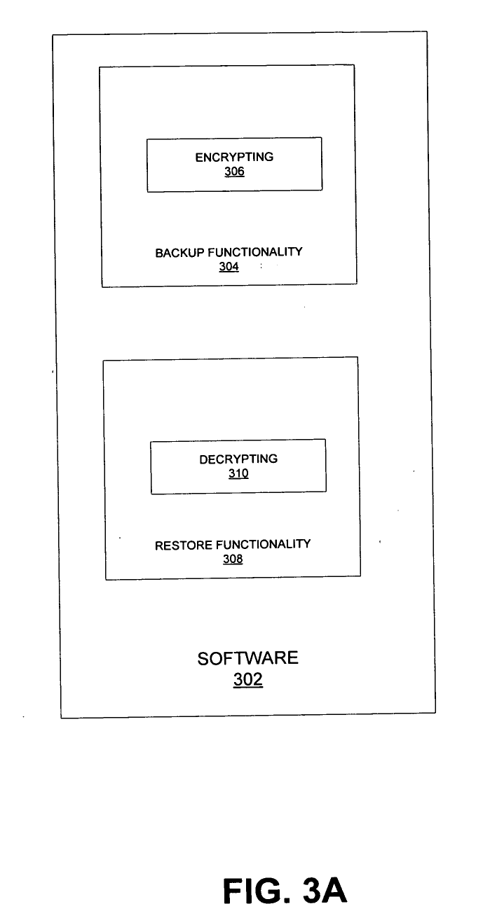

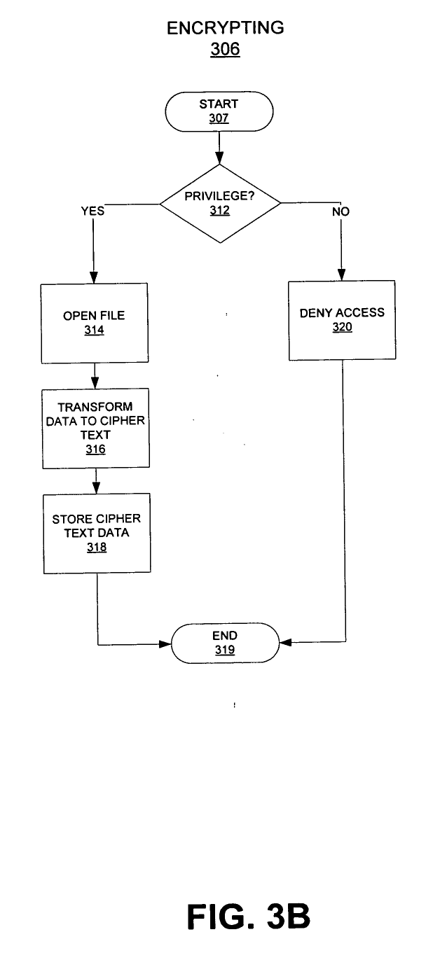

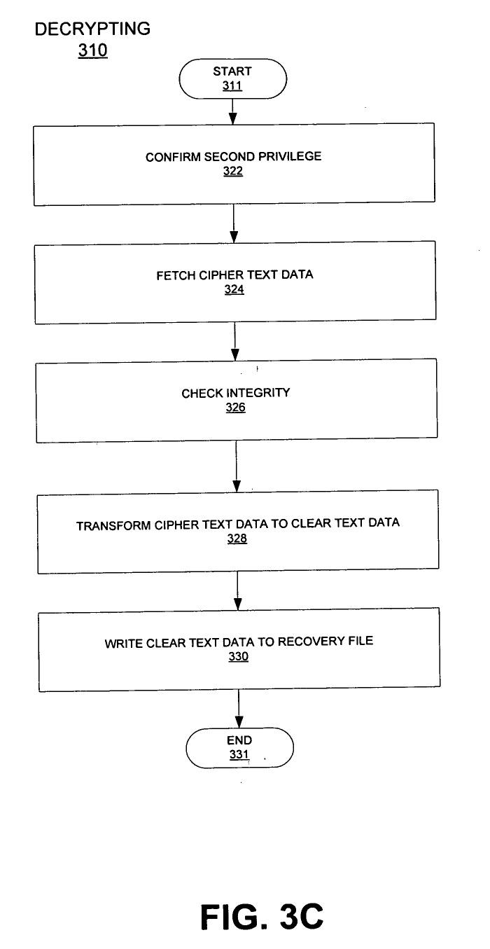

In reference now to FIG. 3A, a diagram of an exemplary software 302 for backing up and recovering data is illustrated, in accordance with an embodiment of the present claimed subject matter. As depicted in FIG. 3A, software 302 includes two functionalities, a backup functionality 304 and a restore functionality 308. The backup functionality 304 further includes encrypting ability 306, which is described in further detail in FIG. 3B. The restore functionality further includes the decrypting ability 310, which is described in further detail in FIG. 3C. Although software 302 of FIG. 3A is shown and described as having certain numbers and types of elements, the present embodiment is not so limited; that is, software 302 of FIG. 3A may include elements other than the ones shown, and may also include more than one of the elements that are shown.

Referring now to FIG. 3B, a flowchart of an exemplary encrypting process 306 (e.g., encrypting ability 306 of FIG. 3A), in accordance with an embodiment of the present claimed subject matter, is illustrated. At block 307 of FIG. 3B, the process starts. In one embodiment, at block 312, confirmation of the existence of a privilege occurs. In one embodiment, in which the privilege holding is confirmed, the process continues from block 312 to block 314 where a file associated with the data to be backed up is opened. In one embodiment, at block 316, the data to be backed up is transformed into cipher text data with a key that is inaccessible by the backup functionality (e.g., backup functionality 304 of FIG. 3A) of the software (e.g., software 302 of FIG. 3A). Referring back to FIG. 3B, in one embodiment, in block 318, the cipher text data is stored in a storage location. At block 319, in one embodiment, the process ends. In another embodiment in which the existence of the privilege referred to in block 312 is not confirmed, access to the file is denied in block 320 and the process ends in block 319. Although specific steps are disclosed in flowchart 306, such steps are exemplary. That is, various embodiments are well suited to performing a variety of other additional steps or variations of the steps recited in flowchart 306. The steps in flowchart 306 may also be performed in an order different than presented.

In reference now to FIG. 3C, a flowchart of an exemplary decrypting process 310 (e.g., decrypting ability 310 of FIG. 3A), in accordance with an embodiment of the present claimed subject matter, is illustrated. At block 311 of FIG. 3C, the process starts. In one embodiment, at block 322, a second privilege associated with the cipher text data is confirmed. At block 324, given that the second privilege is confirmed, in one embodiment, the cipher text data is fetched. At block 326, in one embodiment, the integrity of said cipher text data is checked. At block 328, given the integrity check confirms the integrity of the data, the cipher text data is transformed into cleartext data. At block 330, in one embodiment, cleartext data is written to a recovery file. A recovery file may then be stored in a storage location. In one embodiment, the process ends at block 331. Although specific steps are disclosed in flowchart 310, such steps are exemplary. That is, various embodiments are well suited to performing a variety of other additional steps or variations of the steps recited in flowchart 310. The steps in flowchart 310 may also be performed in an order different than presented.

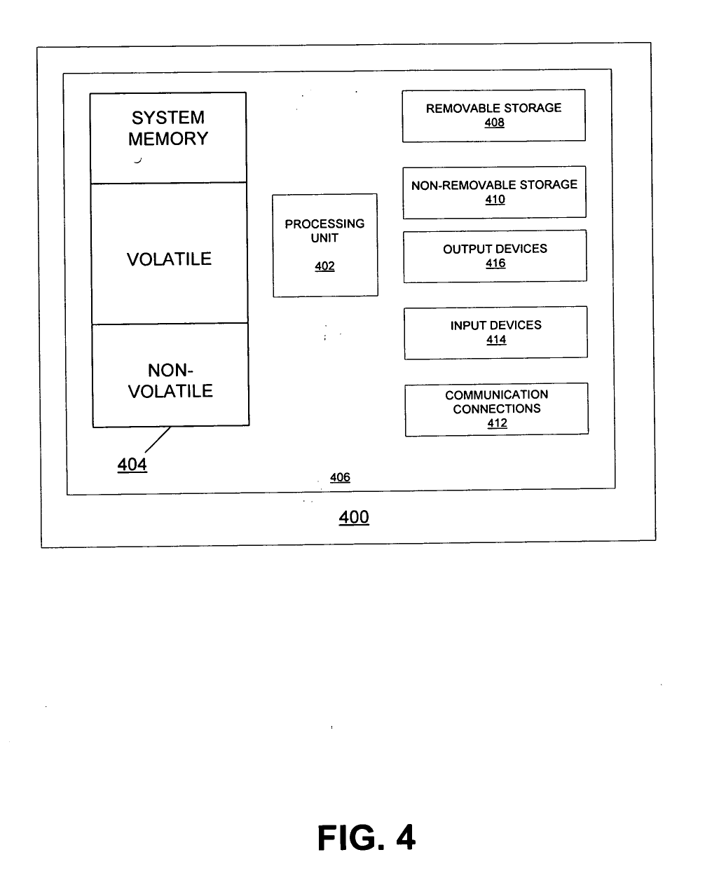

Referring now to FIG. 4, in the context of an exemplary operating environment, FIG. 4 illustrates an exemplary system for implementing the claimed subject matter, in accordance with an embodiment of the present claimed subject matter. With reference to FIG. 4, an exemplary system for implementing the claimed subject matter includes a computing device, such as computing device 400. In its most basic configuration, computing device 400 typically includes at least one processing unit 402 and memory 404. Depending on the exact configuration and type of computing device, memory 404 may be volatile (such as RAM), non-volatile (such as ROM, flash memory, etc.) or some combination of the two. This most basic configuration is illustrated in FIG. 4 by line 406. Additionally, device 400 may also have additional features/functionality. For example, device 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer readable instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400.

Device 400 may also contain communications connection(s) 412 that allow the device to communicate with other devices. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media. The term computer readable media as used herein includes both storage media and communication media.

Device 400 may also have input device(s) 414 such as keyboard, mouse, pen, voice input device, touch input device, etc. Output device(s) 416 such as a display, speakers, printer, etc. may also be included. All these devices are well known in the art and need not be discussed at length here.

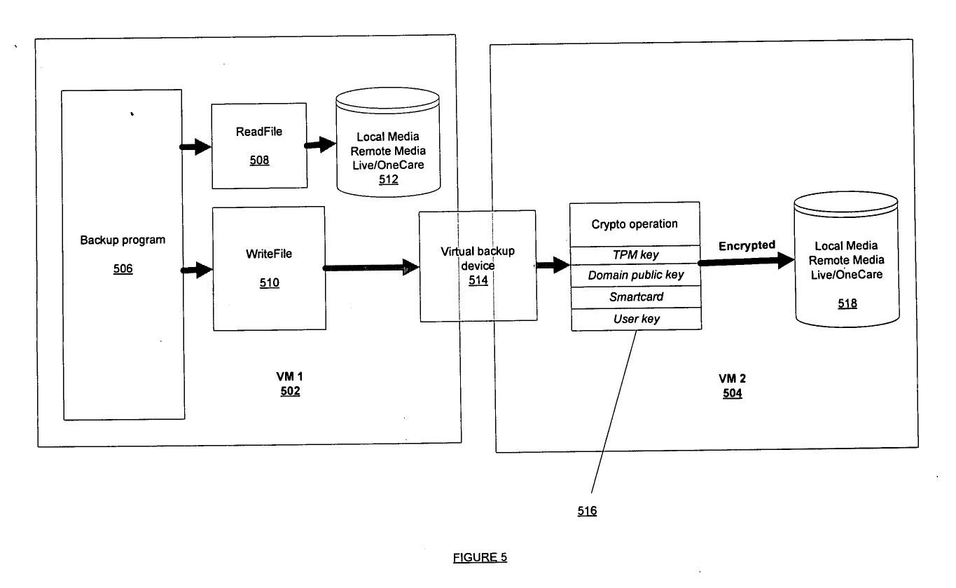

Referring now to FIG. 5, a block diagram of an exemplary backup scenario based on virtual machine isolation is illustrated, in accordance with an embodiment of the present claimed subject matter. As depicted, FIG. 5 includes Backup Program 506, VM 1 and 2 (e.g., virtual machine 502 and 504, respectively), ReadFile 508, WriteFile 510, Media 512, Virtual backup device 514, Crypto operation and Key 516, and Media 518. As depicted, in one embodiment, the backup virtual machine execution environment properties includes: the Backup Program 506 running in virtual machine 1 (e.g., 502) using a Protected Process++model; the backup virtual machine 514 running in a minimal operating system; and virtual machine 2 (e.g., 504) having dedicated disk media, or shared media with virtual machine 1. Although FIG. 5 is shown and described as having certain numbers and types of elements, the present embodiment is not so limited; that is, FIG. 5 may include elements other than the ones shown, and may also include more than one of the elements that are shown.

As depicted in FIG. 5, in one embodiment, the Backup Program 506 opens a file/disk, which is stored in a storage location (e.g., Local Media, Remote Media, Live/OneCare 512), for backup intent. In one embodiment, the Backup Program 506 calls ReadFile 508 to fetch file data. In one embodiment, the Backup Program 506 calls WriteFile 510 to write the fetched data to a backup device (e.g., virtual backup device 514). In one embodiment, virtual machine 2 (e.g., 504) backup handler passes cleartext to a crypto handler (referring to crypto operation and keys 516). In one embodiment, virtual machine 2 (e.g., 504) persists backup data to a storage location, which may be a local or a remote storage (e.g., media 518).

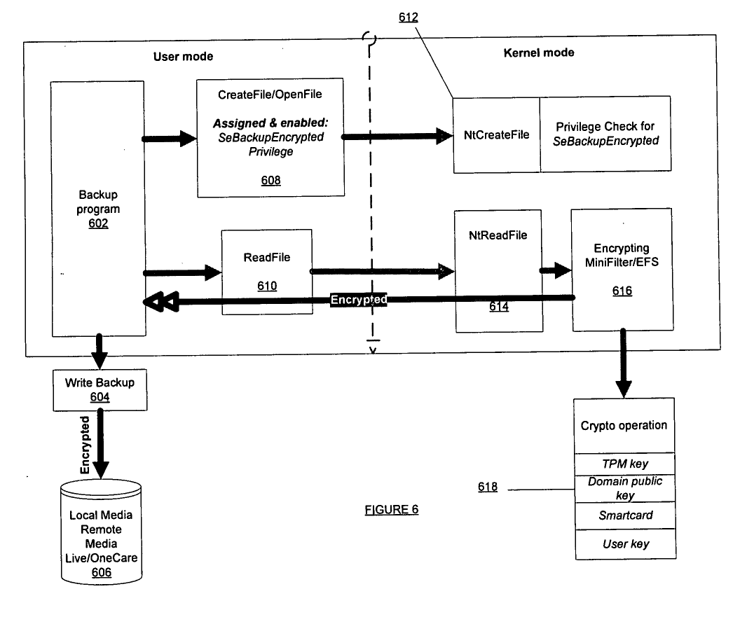

In reference to FIG. 6, a block diagram of an exemplary backup scenario based on account/process and kernel isolation is illustrated, in accordance with an embodiment of the present claimed subject matter. As depicted, FIG. 6 includes Backup Program 602, Write Backup 604, Media 606, CreateFile/OpenFile 608, ReadFile 610, NtCreateFile and Privilege Check 612, NtReadFile 614, Encrypting MiniFilter/EFS 616 and Crypto operation and keys 618. As depicted, in one embodiment, the backup execution environment properties includes: the Backup Program 602 running in a protected process; no 3^{rd} party extensibility points, Backup Program 602 running in low-privileged account; and SeBackupEncrypted Privilege assigned to Service SID. Although FIG. 6 is shown and described as having certain numbers and types of elements, the present embodiment is not so limited; that is, FIG. 6 may include elements other than the ones shown, and may also include more than one of the elements that are shown.

As depicted in FIG. 6, in one embodiment, the Backup Program 602 opens a file/disk for backup intent (referring to 608). In one embodiment, the kernel checks to make sure that the caller (also referred to as a user) has SeBackupEncrypted Privilege (referring to 612). If the caller holds the privilege, then the backup program 602 calls ReadFile 610 to fetch file data. In one embodiment, the kernel retrieves the file data and passes cleartext data to the crypto handler (see 616). In one embodiment, the crypto handler encrypts the file data (see 618) and returns the result in ReadFile buffer. In one embodiment, the Backup Program 602 writes the data (referring to Write Backup 604) to Media 606.

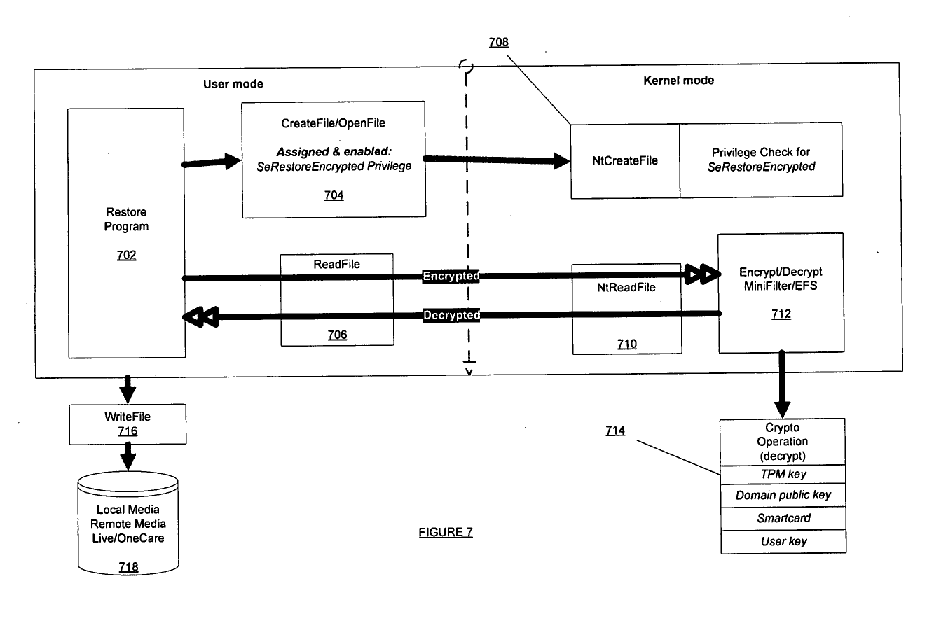

Referring now to FIG. 7, a block diagram of an exemplary restore scenario based on account/process isolation is illustrated, in accordance with an embodiment of the present claimed subject matter. As depicted, FIG. 7 includes Restore Program 702, CreateFile/OpenFile 704, ReadFile 706, NtCreateFile and SeRestoreEncrypted Privilege Check 708, NtReadFile 710, Encrypt/Decrypt MiniFilter/EFS 712, Crypto operation and keys 714, WriteFile 716, and Media 718. Although FIG. 7 is shown and described as having certain numbers and types of elements, the present embodiment is not so limited; that is, FIG. 7 may include elements other than the ones shown, and may also include more than one of the elements that are shown.

As depicted in FIG. 7, in one embodiment, the Restore Program 702 opens previously backed up file/disk for restore intent (refer to CreateFile/Open File 704). In one embodiment, the kernel checks to make sure the caller has SeRestoreEncrypted Privilege (referring to 708). In one embodiment, if the caller holds the privilege, the file handle is returned. In one embodiment, the Restore Program 702 calls ReadFile 706 to fetch file data. In one embodiment, the kernel retrieves file data and passes ciphertext data to the crypto handler 712. In one embodiment, the crypto handler 712 decrypts the file data (referring to 714), conducts an integrity check on the result, and returns cleartext result in the ReadFile buffer. In one embodiment, the Restore Program 702 writes cleartext data to the recovery file (referring to 718), which maybe stored in Media 718.

In the foregoing specification, embodiments have been described with reference to numerous specific details that may vary from implementation to implementation. Thus, the sole and exclusive indicator of what is, and is intended by the applicants to be the claimed subject matter is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of utilizing software for backing up and recovering data, said method comprising:
separating a backup functionality and a restore functionality of said software into at least two independent operations, wherein said backup functionality is isolated from said restore functionality, and wherein said backup functionality comprises encrypting said backup data and said restore functionality comprises decrypting said data.

2. The method of claim 1, further comprising:
confirming the existence of a privilege, wherein if said privilege does not exist, then access to a file associated with said data is denied.

3. The method of claim 1, wherein said encrypting comprises:
opening a file associated with said data;
transforming said data to cipher text data with a key, wherein said key is inaccessible by said backup functionality of said software, and storing said cipher text data in a storage location.

4. The method of claim 3, wherein said decrypting comprises:
fetching said cipher text data;
transforming said cipher text data into clear text data; and
writing said clear text data to a recovery file.

5. The method claim 1, wherein said key is accessible by said restore functionality of said software.

6. The method of claim 1, wherein said key is selected from the group consisting of: a user key, a Trusted Platform Module (TPM), a smartcard, a hardware based token, and a domain public key.

7. A system for backing up and restoring file data, said system comprising:
a backup component for encrypting said file data, wherein file data is transformed into encrypted file data with a key, and wherein said key is stored in an area inaccessible to said backup component; and
a restoring component communicatively coupled with said backup component for decrypting said encrypted file data, wherein said encrypted file data is transformed into cleartext data.

8. The system of claim 7, wherein said backing up and said restoring file data are divided operations capable of being independently performed.

9. The system of claim 7, wherein said file data is transformed into said encrypted file data through a crypto handler.

10. The system of claim 7, further comprising of storing said recovery file in a location selected from the group of locations consisting of: a local media location, a remote media location, and a service provider location.

11. The system of claim 10, wherein Hypervisor partitions are used to divide said backing up and said restoring file data operations.

12. A method for archiving data comprising:
encrypting backup data comprising:
opening said file using a backup software;
encoding said backup data with a key which transforms the backup data into encrypted data;
storing said key in an area inaccessible to said backup storage; and
writing said encrypted data to a storage location.

13. The method of claim 12, wherein said archiving data further comprises decrypting said encrypted data, wherein said decrypting comprises:
opening said file associated with said encrypted data using a restore program;
obtaining said key; and
writing cleartext data associated with said encrypted data to a recovery file.

14. The method of claim 13, wherein a refactoring of said backup software results in said encrypting and said decrypting as separate operations.

15. The method of claim 12, wherein said opening said file comprises checking for a privilege associated with said data.

16. The method of claim 12, wherein access to said key is based on input from a user.

17. The method of claim 12, wherein said storage location is selected from the group consisting of: a local media, a remote media, and a service provider.

18. The method of claim 14, wherein said encrypting and said decrypting are separate, independent processes defined by separate module codes.

19. The method of claim 18, wherein said encrypting and said decrypting modules are separated by utilizing virtual machine technologies.

20. The method of claim 19, wherein said encrypting and said decrypting modules are separated by utilizing user account isolation.
